(19) United States
(12) Patent Application Publication
(10) Pub. No.: US 2026/0051985 A1
(43) Pub. Date: Feb. 19, 2026

(54) TECHNOLOGIES FOR SUPPORTING SPATIAL-DOMAIN MULTIPLEX BASED SIMULTANEOUS UPLINK TRANSMISSIONS

(71) Applicant: Apple Inc., Cupertino, CA (US)

(72) Inventors: Haitong Sun, Saratoga (CA); Chunhai Yao, Beijing (CN); Seyed Ali Akbar Fakoorian, San Diego, CA (US); Hong He, San Jose, CA (US); Dawei Zhang, Saratoga, CA (US); Ankit Bhamri, Haar (DE); Wei Zeng, Saratoga, CA (US); Huaning Niu, San Jose, CA (US)

(73) Assignee: Apple Inc., Cupertino, CA (US)

(21) Appl. No.: 19/103,544

(22) PCT Filed: Aug. 12, 2022
(86) PCT No.: PCT/CN2022/112239

§ 371 Date: Feb. 12, 2025

(51) Int. Cl. H04L 5/00; H04L 27/26; H04W 72/044

(52) U.S. Cl. CPC H04L 5/0044; H04L 27/261; H04W 72/046

(57) ABSTRACT

The present application relates to devices and components including apparatus, systems, and methods for supporting single downlink control information, spatial-division multiplexed simultaneous physical uplink shared channel transmissions.

### TECHNICAL FIELD

The present disclosure generally relates to wireless communication, and in particular, to technologies for supporting spatial-domain multiplex based simultaneous uplink transmissions.

### BACKGROUND

Third Generation Partnership Project (3GPP) Technical Specifications (TSs) define standards for wireless networks. These TSs describe aspects related to providing multiple-input, multiple-output (MIMO) communication over a radio interface.

### BRIEF DESCRIPTION OF THE DRAWINGS

FIG. 1 illustrates a network environment in accordance with some embodiments.

FIG. 2 illustrates a transport block signaling modes in accordance with some embodiments.

FIG. 3 illustrates precoders in accordance with some embodiments.

FIG. 4 illustrates an operational flow/algorithmic structure in accordance with some embodiments.

FIG. 5 illustrates another operational flow/algorithmic structure in accordance with some embodiments.

FIG. 6 illustrates another operational flow/algorithmic structure in accordance with some embodiments.

FIG. 7 illustrates a user equipment in accordance with some embodiments.

FIG. 8 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

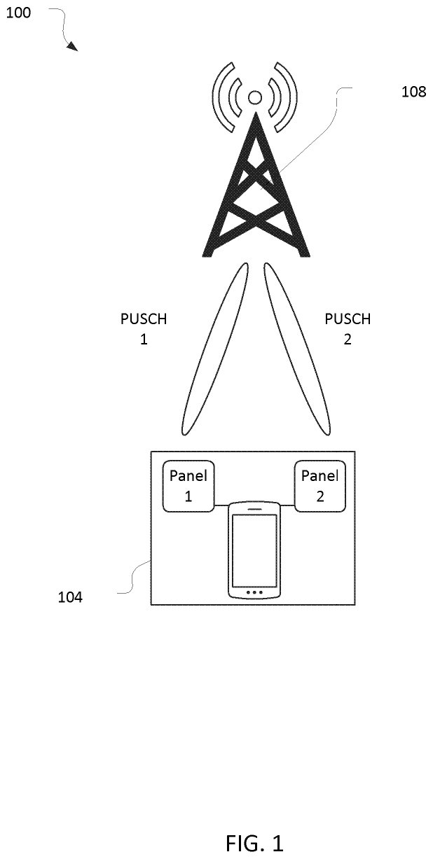

FIG. 1 illustrates a network environment 100 in accordance with some embodiments. The network environment 100 may include a user equipment 104 and a base station 108. In some embodiments, the base station 108 may provide one or more wireless access cells through which the UE 104 may communicate with a cellular network.

The UE 104 and the base station 108 may communicate over air interfaces compatible with Fifth Generation (5G) new radio (NR) or later system standards as provided by 3GPP TSs. If the base station 108 is deployed in a 5G radio access network (RAN) it may also be referred to as gNB 108.

NR uplink supports two MIMO operation modes and up to four transmission layers. The first MIMO operation mode may be a codebook-based uplink in which a sounding reference signal (SRS) resource set usage is set to “codebook.” In this operation mode, the UE 104 may transmit an SRS resource with a plurality of ports. The base station 108 may then schedule a physical uplink shared channel (PUSCH) transmission by providing a precoding and layer information (PL) field in DCI to indicate precoding information (for example, a transmitted precoding matrix indicator (TPMI)) and a number of layers (for example, a rank indicator (RI)). The base station 108 may also provide an SRS resource indicator (SRI) to select the SRS resource that is used as a reference for the information conveyed by the PL field.

The second MIMO operation mode may be a non-codebook-based uplink in which a SRS resource set usage is set to “non-Codebook.” In this operation mode, the UE 104 may measure channel state information-reference signals (CSI-RS) and use these measurements to derive precoding weights for configured SRS resources. This operation mode assumes downlink-uplink channel reciprocity. The UE 104 may then transmit a plurality of SRS resources from a corresponding plurality of ports using its calculated precoding weights. The base station 108 may then schedule a PUSCH transmission by providing a SRS resource indicator (SRI) to indicate an SRS resource/port selection (and precoding matrix used for selected SRS transmission) and a number of layers (for example, RI).

The UE 104 may include a plurality of antenna panels with each antenna panel having an array of antenna elements. As shown, the UE 104 has two antenna panels, panel 1 and panel 2. The UE 104 may use panel 1 and panel 2 to simultaneously transmit uplink signals in a spatial-domain multiplexing (SDM) manner. As shown, the UE 104 transmits PUSCH 1 from panel 1 and transmits PUSCH 2 from panel 2. PUSCH 1 and PUSCH 2 may be transmitted at the same time and frequencies.

The base station 108 may schedule simultaneous PUSCH transmissions in a SDM manner by using single downlink control information (DCI) or multiple-DCI (multi-DCI). For single-DCI based scheduling, one DCI is used to schedule a plurality of overlapping simultaneous PUSCH transmissions. For multi-DCI based scheduling, each overlapping simultaneously PUSCH transmission may be scheduled by a corresponding DCI.

There are two possible modes for single-DCI, SDM-based simultaneous PUSCH transmission. In a first mode, each panel/PUSCH may only occupy non-overlapping PUSCH layers. In this mode, each layer of a MIMO transmission may be subject to different precoding. Consider, for example, a MIMO transmission having four layers. In this example, the first mode may be used to transmit two layers from panel 1 and a different two layers from panel 2.

In a second mode, each panel/PUSCH may occupy the same PUSCH layer. This may be similar to a single-frequency network in which the layers are transmitted with the same beam and completely overlap one another. The layers may then be coherently combined by a receiver.

Developing NR networks may support multi-panel simultaneous PUSCH transmissions. Various embodiments of the present disclosure describe technologies to support single-DCI, SDM-based simultaneous PUSCH transmissions. Aspects of these embodiments include the use of two sets of SRI (PL) fields, a single set of SRI (PL) fields, and aperiodic-channel state information (AP-CSI) transmissions.

A first aspect described herein may correspond to a single-DCI, SDM-based simultaneous PUSCH transmission in which the base station configures and uses two sets SRI (PL) fields in a same DCI to schedule simultaneous PUSCH transmissions. As used herein, a set of SRI (PL) fields may indicate either an SRI field only (as used for non-codebook based operation) or both an SRI field and a PL field (as used for codebook-based operation). A number of options for the first aspect are described below. These options are not mutually exclusive and various of these options may be used together in some instances.

In a first option of the first aspect, each SRI (PL) fields may correspond to different antenna panels. For example, the base station 108 may provide the UE 104 with one DCI that includes first SRI (PL) fields and second SRI (PL) fields. The first SRI (PL) fields may schedule PUSCH 1 from panel 1, while the second SRI (PL) fields may schedule PUSCH 2 from panel 2.

In a second option of the first aspect, additional signaling may be used to provide an indication that the simultaneous PUSCH transmissions are scheduled with an SDM transmission scheme as opposed to another simultaneous PUSCH transmission scheme such as, for example, frequency division multiplexing (FDM) or time division multiplexing (TDM). In one example, the base station 108 may transmit information in radio resource control (RRC) signaling to configure the UE 104 with the SDM transmission scheme. In another example, the base station 108 may transmit a media access control-control element (MAC-CE) to activate the SDM transmission scheme. In some embodiments, the UE 104 may be configured with the plurality of transmission schemes (either predefined or configured through RRC signaling) and the MAC-CE may be used to activate the SDM transmission scheme from the plurality of transmission schemes. It may be desirable that only one transmission scheme be activated at a particular time. In yet another example, the SDM transmission scheme may be dynamically indicated by DCI for such as, for example, the DCI used to schedule the PUSCH transmissions.

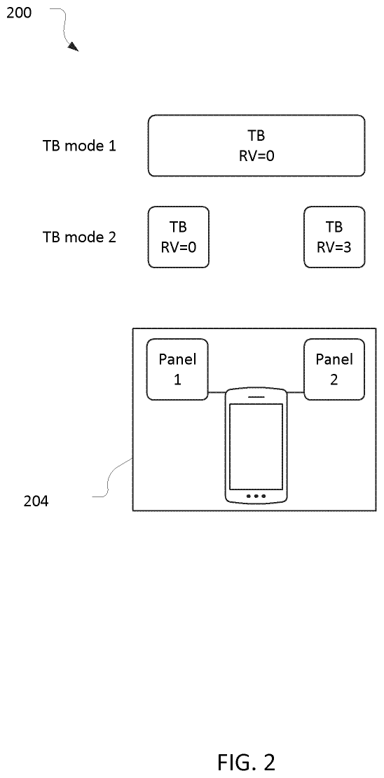

In a third option of the first aspect, two modes of transmitting the transport block (TB) are described. These two modes are illustrated in FIG. 2 in accordance with some embodiments.

A first mode, which may be referred to as TB mode 1, may include a single TB jointly transmitted from both antenna panel 1 and antenna panel 2. In this situation, both the first and second SRI (PL) fields may be used to schedule the TB from both antenna panels. Consider, for example, that a simultaneous PUSCH transmission is scheduled over four layers, with the first two layers to be transmitted by antenna panel 1 and the second two layers to be transmitted by antenna panel 2. Using TB mode 1, the UE 104 may jointly encode the TB on all four layers, with only one rate matching being performed.

In a second mode, which may be referred to as TB mode 2, a single TB may be independently transmitted from each antenna panel. In this situation, the first SRI (PL) fields may be used to schedule the TB from antenna panel 1 and the second SRI (PL) may be used to schedule the TB from antenna panel 2. Consider the same example as given above in which a simultaneous PUSCH transmission is scheduled over four layers, with the first two layers to be transmitted by antenna panel 1 and the second to layers two be transmitted by antenna panel 2. Using TB mode 2, the UE 104 may encode the TB on the first two layers and perform rate matching based on those layers for transmission by antenna panel 1. The UE 104 may separately encode the TB on the second two layers and perform rate matching based on those layers for transmission by antenna panel 2.

In TB mode 2, the single TB may be transmitted with the same redundancy version (RV) or different RVs from the two antenna panels. FIG. 2 shows different RVs with the TB transmitted from antenna panel 1 with RV=0 and the TB transmitted from antenna panel 2 with RV=3.

While the above embodiment describes TB mode 2 simultaneously transmitting the same TB from the two antenna panels, other embodiments may use TB mode 2 to simultaneously transmit different TBs from the two antenna panels.

A fourth option of the first aspect describes the determination of the TB size for TB mode 1 and TB mode 2.

For TB mode 1, the TB size may be determined by jointly computing a total number of available resource elements (REs)/bits from both antenna panels as scheduled by the first/second SRI (PL) fields. Consider the example given above in which the simultaneous PUSCH transmission is scheduled on four layers equally distributed among the two antenna panels. In this example, the TB size may be based on the total number of REs available in all four layers.

For TB mode 2, the UE 104 may first compute a total number of available REs/bits from the first panel. This may be based on the first SRI (PL) fields. The UE 104 may then assume the same TB size for the second antenna panel. Consider the example given above in which the simultaneous PUSCH transmission is scheduled on four layers equally distributed among the two antenna panels. In this example, the UE 104 may compute the total number of available REs on the first two layers. The UE 104 may then use this number for encoding the TB on the first two layers for transmission by antenna panel 1 and for encoding the TB on the second two layers for transmission by antenna panel 2. In another example, a different number of layers may be scheduled for different panels (e.g., panel 1 is scheduled with two layers and panel 2 is scheduled with one layer). In this example, since there is one TB, the TB size may be determined based on one antenna panel. If antenna panel 1 is selected, the TB size will be determined based on two layers. Then, for the second antenna panel, since it only has one layer, the available REs is likely to be less. Thus, the UE would perform rate matching to fit the TB into the second antenna panel.

A fifth option of the first aspect describes determination of an RV to use when simultaneous PUSCH transmissions are scheduled for TB mode 2. The UE 104 may determine a first RV (RV_1) to use for the PUSCH transmission from the antenna panel 1 based on the RV field of the DCI that schedules the PUSCH transmission. The UE 104 may then determine a second RV (RV_2) to use for the PUSCH transmission from antenna panel 2 based on RV_1.

In some embodiments, RV_2 may be determined based on an RV offset (RV_offset), which may be predefined or configured by RRC signaling from the base station 108. For example, the second RV may be determined as follows:

$$RV\_ 2 = ( RV\_ 1 + RV\_offset ) mod 4.$$

In other embodiments, an association between RV_1 and RV_2 may be predefined or configured by the base station 108. For example, the UE 104 may be provided with information to configure an RV association as provided in Table 1.

TABLE 1

| | | | | |
|---|---|---|---|---|
| RV_1 | 0 | 2 | 3 | 1 |
| RV_2 | 2 | 3 | 1 | 0 |

Based on Table 1, if the RV field sets the RV for the first panel to 0, the UE 104 may determine that the RV for the second panel is 2, if the RV field sets the RV for the second panel to 2, the UE 104 may determine that the RV for the second panel is 3, and so on.

A sixth option of the first aspect describes phase tracking reference signal (PTRS)-to-demodulation reference signal (DMRS) port mapping. The PTRS-to-DMRS port mapping may be used to tell the UE 104 which layer should be used for a PTRS transmission.

The PTRS may be transmitted by two antenna ports. If each SRI(PL) field schedules≤2 PUSCH layers, a two-bit PTRS-DMRS association field may be used to provide the layers from the first and second antenna panels for the two PTRS ports. For example, a first bit of the PTRS-DMRS association field may be used to indicate which layer from the first antenna panel is to be used for the first PTRS port, while a second bit of the PTRS-DMRS association field may be used to indicate which layer from the second antenna panel is to be used for the second PTRS port. The first bit may be the most significant bit (MSB) or the least significant bit (LSB), and the second bit may be the LSB or the MSB.

If each SRI (PL) field schedules>2 PUSCH layers, two PTRS-DMRS association fields may be used to provide the layers from the first and second antenna panels for the two PTRS ports. Each PTRS-DMRS association field may be a two-bit field. The two bits of the first PTRS-DMRS association field may be used to indicate which layer from the first antenna panel is to be used for the first PTRS port, while the two bits of the second PTRS-DMRS association field may be used to indicate which layer from the second antenna panel is to be used for the second PTRS port.

A second aspect of the disclosure corresponds to a single-DCI, SDM-based simultaneous PUSCH transmission in which the base station 108 configures and uses one set of SRI (PL) fields in a same DCI to schedule the simultaneous PUSCH transmissions. A number of options for the second aspect are described below. These options are not mutually exclusive and various of these options may be used together in some instances.

A first option of the second aspect may correspond to non-codebook PUSCH operation.

In some embodiments, a single SRS resource set with usage=“nonCodebook” may be configured. The SRS resources may be statically partitioned among the two antenna panels. Assuming, for example, two SRS resources per panel, panel 1 may be associated with SRS resource 1 and 2 and antenna panel 2 may be associated with SRS resource 3 and 4. However, other associations may be provided.

Statically partitioning the different SRS resources to the different panels may provide the base station 108 with information about a precoded SRS resource transmitted by the UE 104 in a non-codebook-based operation. The base station 108 may then set a single SRI in a manner to instruct the UE 104 to transmit a particular number of layers from specific antenna panels.

The single SRI may be set based on an SRI table available to both the UE 104 and the base station 108. The SRI table may be predefined or configured by the base station 108. One example of an SRI table is shown as Table 2 as follows.

TABLE 2

| SRI | Selected SRS |
|---|---|
| 0 | (1) |
| 1 | (2) |
| 2 | (3) |
| 3 | (4) |
| 4 | (1, 2) |
| 5 | (3, 4) |
| 6 | (1, 3, 4) |
| 7 | (2, 3, 4) |
| 8 | (1, 2, 3) |
| 9 | (1, 2, 4) |
| 10 | (1, 2, 3, 4) |

Thus, the base station 108 may set an SRI field to a value of ‘6,’ for example, to indicate that the UE 104 is to use one layer from antenna panel 1 (corresponding to SRS resource 1) and two layers from antenna panel 2 (corresponding to SRS resources 3 and 4).

In some embodiments, a plurality of SRS resource sets (for example, two SRS resource sets) with usage=“nonCodebook” may be configured. In these embodiments, the SRS resource set with the smaller index may map to the first antenna panel and the SRS resource set with the larger index may map to the second antenna panel. The base station 108 may use a single SRI mapped to selection of an SRS resource from the first or second SRS resource sets in a manner similar to that discussed above with respect to Table 2.

A second option of the second aspect may correspond to codebook PUSCH operation. In some embodiments, only partial or non-coherent codebooks may be allowed. In these embodiments, it may be assumed that there is no coherency between the antenna panels, although coherency may exist within a particular antenna panel. Thus, a single layer may be transmitted either from the first or second antenna panel, but not from both.

Operations with only partial or non-coherent codebooks allowed may be enabled by defining a PUSCH layer-to-panel mapping. In some instances, this mapping may be that even PUSCH ports (for example, port 0 and port 2) are mapped to the first antenna panel and odd PUSCH ports (for example, port 1 and port 3) are mapped to the second antenna panel.

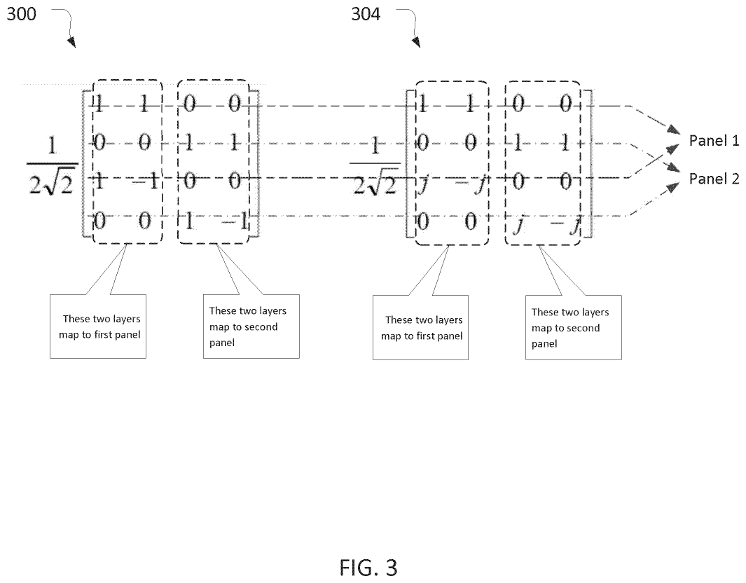

FIG. 3 illustrates partially or non-coherent precoders that may be used in accordance with some embodiments. In particular, FIG. 3 includes a first precoder 300 and a second precoder 304. For either the first precoder 300 or the second precoder 304, the even rows (for example, port 0 and port 2) may be transmitted from the first antenna panel, and, the odd rows (for example, port 1 and port 3) may be transmitted from the second antenna panel.

Each column of the precoders 300 and 304 may correspond to a respective transmission layer, and each row of the precoders 300 and 304 may correspond to a respective transmission port.

According to the PUSCH layer-to-panel mapping defined above, ports 0 and 2 correspond to antenna panel 1, while ports 1 and 3 correspond to antenna panel 2.

With reference to the first precoder 300, the first two layers map to the first antenna panel given that the non-zero values are in the first row (corresponding to port 0) and the third row (corresponding to port 2). The second two layers map to the second antenna panel given that their non-zero values are in the second row (corresponding to port 1) and the fourth row (corresponding to port 3).

The second precoder 304 may be similar to the first precoder except that the non-zero values of ports 2 and 3 are 90 degrees phase rotated as compared to the corresponding values of the first precoder.

In other embodiments, coherent codebooks may be allowed. In these embodiments, the UE 104 may report whether it supports coherent transmissions between different panels. This report may be in a UE capability report that is provided at the time of establishing a connection with the base station 104 or at a later time.

There may be no need for layer-to-panel mapping when coherent transmission is configured across both antenna panels since each layer may be transmitted from both panel simultaneously.

In addition to providing data in the transport block, the simultaneous PUSCH transmissions may include uplink control information (UCI) such as an AP-CSI report that is triggered by a CSI request field in the DCI that schedules the PUSCH transmissions. A third aspect of the disclosure relates to single-DCI, SDM-based simultaneous PUSCH transmission when the network uses single DCI to schedule simultaneous transmission of PUSCH transmissions with an AP-CSI report.

When a TB is jointly encoded from both panels as discussed above with respect to TB mode 1, the AP-CSI report may be jointly transmitted from both panels. For example, if the AP-CSI report has 1001 bits, the 1001 bits may be encoded onto REs available from layers transmitted by both antenna panels.

When a single TB is transmitted from the two antenna panels with independent coding (and possibly RVs) as discussed above with respect to TB mode 2, there may be two options for transmitting the AP-CSI report.

In a first option, the AP-CSI may only be transmitted from one antenna panel (either antenna panel 1 or antenna panel 2, but not both).

In a second option, the AP-CSI may be independently encoded for transmission from both antenna panels. This may be done in one of two ways.

In a first way for independently encoding AP-CSI for transmission by both panels, the AP-CSI report may be divided into two portions. Each portion may have a substantially equal number of bits, with each of the portions transmitted from a different antenna panel. For example, if the AP-CSI report has 1001 bits, a first portion, including 500 bits, may be transmitted from antenna panel 1 while a second portion, including the remaining 501 bits, may be transmitted from antenna panel 2.

In the event the layers of the first panel or the layers of the second panel are not able to support their respective portions, UCI omission may be necessary. In this embodiment, the UCI omission may be performed independently for each panel. For example, if the number of bits available for AP-CSI transmission by the layers of the first panel is less than 500, the first portion may be reduced accordingly. Similarly, if the number of bits available for AP-CSI transmission by the layers of the second panel is less than 501, the second portion may be reduced accordingly.

In a second way for independently encoding AP-CSI for transmission by both panels, the same AP-CSI report may be transmitted from both panels. For example, the 1001 bits of the AP-CSI report may be encoded onto the layers of antenna panel 1 for transmission and may be separately encoded onto the layers of antenna panel 2 for transmission.

UCI omission for this embodiment may be provided using one of the following options.

In a first option, the carrying capacity of both panels may be considered and UCI omission may be performed on the AP-CSI report to ensure that the UCI size limitation is not exceeded for either of the two panels. For example, if the first panel can support 800 bits and the second panel can support 600 bits, the UCI omission may be performed based on the 600 bits. In this manner, the same AP-CSI report may be transmitted by both antenna panels.

In a second option, the carrying capacity of only one of the panels may be considered, for example, antenna panel 1 or antenna panel 2. In the scenario described above in which the first panel can support 800 bits and the second panel can support 600 bits, and the carrying capacity is based on the first panel, the second antenna panel may not be able to carry the AP-CSI report. Instead, the AP-CSI report may be transmitted solely from the layers on the first antenna panel.

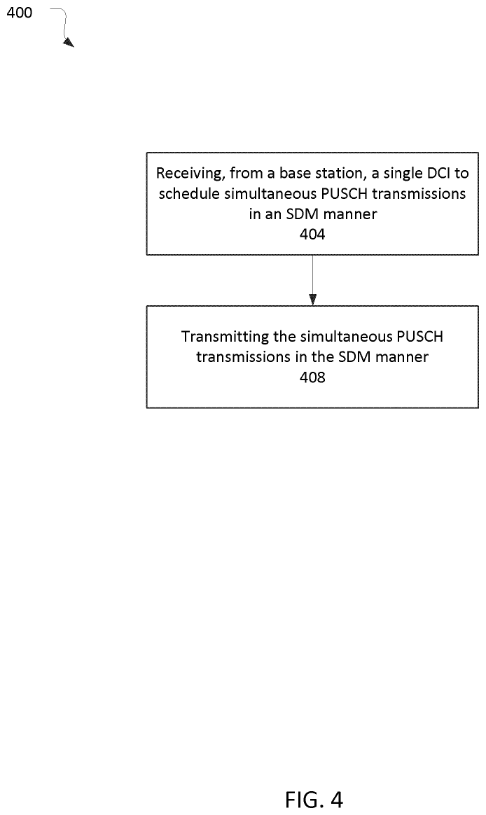

FIG. 4 includes an operation flow/algorithmic structure 400 in accordance with some embodiments. The operation flow/algorithmic structure 400 may be performed or implemented by a device such as, for example, UE 104 or UE 700; or components thereof, for example, processors 704.

The operation flow/algorithmic structure 400 may include, at 404, receiving a single DCI to schedule simultaneous PUSCH transmissions in an SDM manner. In some embodiments, the single DCI may include one or more first indicator fields corresponding to a first PUSCH transmission and one or more second indicator fields corresponding to a second PUSCH transmission. In other embodiments, the single DCI may include one or more first indicator fields corresponding to both the first PUSCH transmission and the second PUSCH transmission. The indicator fields may be SRI(PL) fields that provide information related to SRS resources, TPMI, or number of layers to be used with the various PUSCH transmissions.

In some embodiments, the UE may receive a control signal from the base station that indicates the simultaneous PUSCH transmissions are scheduled in an SDM manner. This control signal may be an RRC signal, a MAC-CE, or DCI.

Upon receiving the single DCI, the UE may encode a TB for the first/second PUSCH transmissions. The TB may be encoded onto a plurality of layers distributed across first and second antenna panels of the UE. In this instance, a total number of available resource elements from the plurality of layers may be used to determine a TB size for encoding the TB.

In some embodiments, the TB may be separately encoded onto layers associated with separate antenna panels. For example, if first and second layers are associated with the first antenna panel and third and fourth layers are associated with the second antenna panel, the TB may be encoded onto the first/second layers and, separately, the TB may be encoded onto the third/fourth layers. The UE may determine a TB size based on a total number of available resource elements from the layers associated with the first panel.

The TB may be encoded on layers of the first panel and onto layers of the second panel with the same or different RVs. In some embodiments, a first RV for encoding on the layers of the first panel may be signaled by an MCS field and a second RV for encoding on the layers of the second panel may be determined based on a predefined offset from the first RV or a predefined association with the first RV.

In some embodiments, the single DCI may include one or more PTRS-DMRS association fields. If the first/second indicator fields each schedule two or fewer PUSCH layers, one PTRS-DMRS association field may be used with one of the bits being used to indicate which PUSCH layer from the first antenna panel is to be used for a first PTRS port and the other bit being used to indicate which PUSCH layer from the second antenna panel is to be used for a second PTRS port. If at least one of the first/second indicator fields schedule more than two PUSCH layers, then two, two-bit PTRS-DMRS association fields may be used. The two-bits from the first PTRS-DMRS association field may be used to indicate which PUSCH layer from the first antenna panel is to be used for a first PTRS port and the two-bits from the first PTRS-DMRS association field may be used to indicate which PUSCH layer from the second antenna panel is to be used for a second PTRS port.

Embodiments in which one or more first indicator fields (for example, one SRI field and, optionally, one PL field) are used to schedule both the first and second PUSCH transmissions may correspond to both non-codebook-based PUSCH operation and codebook-based PUSCH operation.

For non-codebook-based PUSCH operation, certain SRS resources may be associated with certain antenna panels. For example, the first and second SRS resources may be associated with the first antenna panel, while the third and fourth SRS resources are associated with the second antenna panel. The base station may signal an SRI that corresponds to one or more of the SRS resources and the UE will know the panel to use for the uplink transmissions based on the SRS resource-to-panel associations.

For codebook-based PUSCH operation, the UE and base station may use partial-coherent or non-coherent codebooks in some embodiments. A PUSCH layer to panel mapping may be predefined or otherwise configured. For example, even antenna ports may belong to the first antenna panel and odd antenna ports may belong to the second panel. The base station may then select a precoder from the codebook that may be used to precode the PUSCH layers on even or add antenna ports mapped to appropriate antenna panels. The selected precoder may be signaled by the TPMI indicated by the PL field.

The operation flow/algorithmic structure 400 may further include, at 408, transmitting the simultaneous PUSCH transmissions in the SDM manner. These transmissions may be based on encoding operations described elsewhere herein.

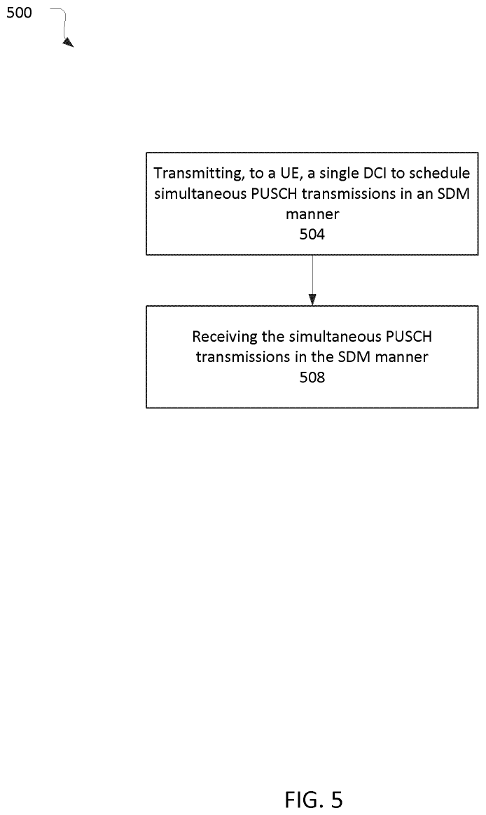

FIG. 5 includes an operation flow/algorithmic structure 500 in accordance with some embodiments. The operation flow/algorithmic structure 500 may be performed or implemented by a device such as, for example, base station 108 or base station 800; or components thereof, for example, processors 804.

The operation flow/algorithmic structure 500 may include, at 504, transmitting a single DCI to schedule simultaneous PUSCH transmissions in an SDM manner. The single DCI may be generated by the base station and transmitted to a UE. The single DCI may be similar to that described above with respect to FIG. 4 and elsewhere herein. In some embodiments, the single DCI may also trigger an AP-CSI report to be transmitted with the simultaneous PUSCH transmissions.

The operation flow/algorithmic structure 500 may further include, at 508, receiving the simultaneous PUSCH transmissions in the SDM manner. In some embodiments, the base station may also receive an AP-CSI report with the simultaneous PUSCH transmissions.

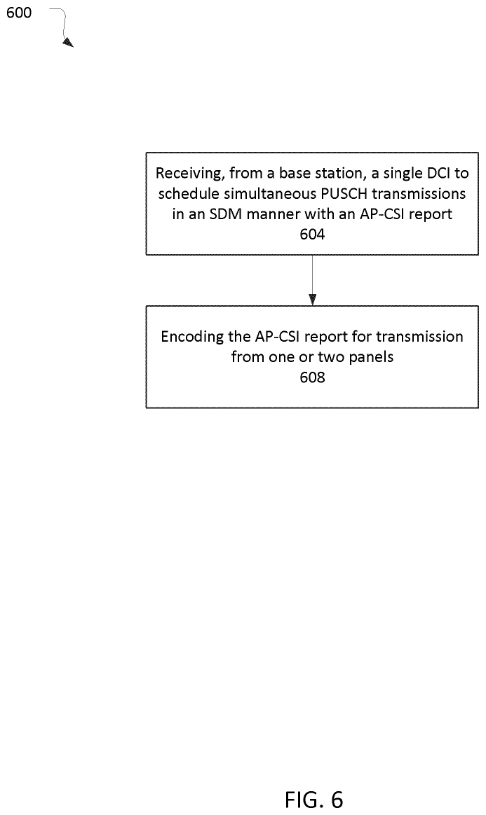

FIG. 6 includes an operation flow/algorithmic structure 600 in accordance with some embodiments. The operation flow/algorithmic structure 600 may be performed or implemented by a device such as, for example, UE 104 or UE 700; or components thereof, for example, processors 704.

The operation flow/algorithmic structure 600 may include, at 604, receiving a single DCI to schedule simultaneous PUSCH transmissions in an SDM manner with an AP-CSI report. The single DCI may be similar to that described above with respect to FIG. 4 and elsewhere herein. In this embodiments, the single DCI may also trigger an AP-CSI report to be sent with the PUSCH transmissions.

AP-CSI report may be encoded for transmission from one or two antenna panels of the UE.

In some embodiments, when TB mode 1 is used to transmit the TB, the AP-CSI report may be jointly transmitted from both antenna panels. For example, the AP-CSI report may be encoded onto a plurality of layers that are spread among the first and second antenna panels.

In some embodiments, when TB mode 2 is used to transmit the TB, the AP-CSI report may only be transmitted from one panel, for example, antenna panel 1 or antenna panel 2.

In other embodiments, when TB mode 2 is used to transmit the TB, the AP-CSI report may be transmitted from both panels.

A first method of transmitting the AP-CSI report from both panels may be done by encoding a first portion of the AP-CSI report onto layers to be transmitted by the first antenna port and encoding a second portion of the AP-CSI report onto layers to be transmitted by the second antenna port. The first and second portions may be different portions. UCI omission may be done independently for each panel. For example, the UE may determine a first number of resource elements available for the first portion of the AP-CSI report from the layers to be transmitted from the first antenna panel and may adjust a size of the first portion if necessary. For example, if the first portion is greater than the number of available resource elements, UCI omission may be performed to reduce the size of the first portion. A similar process may be performed with respect to the second portion on the layers to be transmitted from the second antenna panel.

A second method of transmitting the AP-CSI report from both panels may be done by separately encoding the AP-CSI report onto layers to be transmitted by separate panels. For example, the AP-CSI report may be encoded onto layers to be transmitted by the first panel and, separately, may be encoded onto layers to be transmitted by the second panel.

For purposes of UCI omission, both panels may be considered or one panel may be considered. For example, if both panels are considered, the UE may determine which layers of the first or second panels have fewer resource elements available for the AP-CSI report. The UE may then adjust the size of the AP-CSI report based on the fewer resource elements to ensure that the UCI size limitation is not exceeded for either panel. If only one panel is considered, the AP-CSI size may be determined based on the number of resource elements available for the AP-CSI report on the layers of that panel. If the layers of the other panel can also accommodate the AP-CSI report, it may be sent on the other panel as well. If not, it may be dropped from the other panel.

The operation flow/algorithmic structure 600 may further include, at 608, encoding the AP-CSI report for transmission from one or two panels. The AP-CSI report may be transmitted with the simultaneous PUSCH transmissions in the SDM manner.

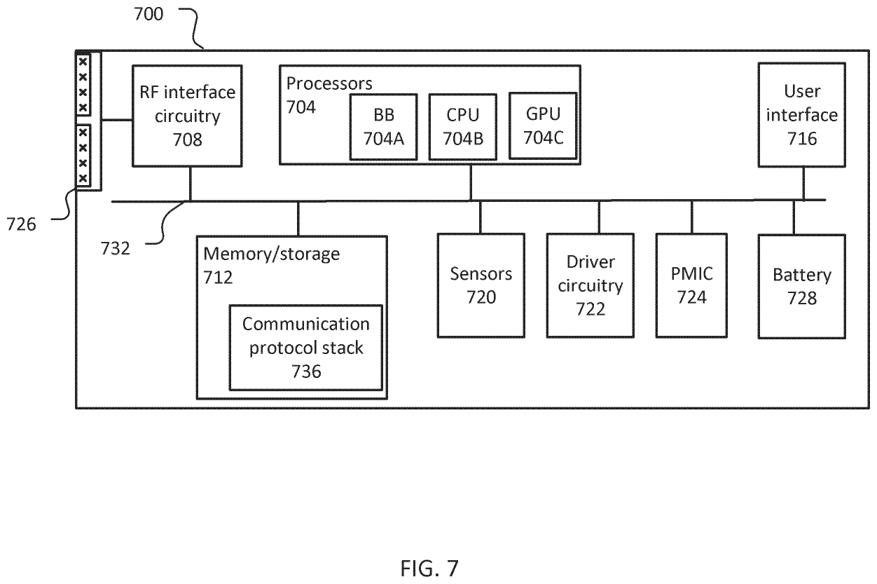

FIG. 7 illustrates an example UE 700 in accordance with some embodiments. The UE 700 may be any mobile or non-mobile computing device, such as, for example, a mobile phone, a computer, a tablet, an industrial wireless sensor (for example, a microphone, a carbon dioxide sensor, a pressure sensor, a humidity sensor, a thermometer, a motion sensor, an accelerometer, a laser scanner, a fluid level sensor, an inventory sensor, an electric voltage/current meter, or an actuators), a video surveillance/monitoring device (for example, a camera), a wearable device (for example, a smart watch), or an Internet-of-things (IOT) device.

The UE 700 may include processors 704, RF interface circuitry 708, memory/storage 712, user interface 716, sensors 720, driver circuitry 722, power management integrated circuit (PMIC) 724, antenna structure 726, and battery 728. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 732, which may represent any type of interface, input/output, bus (local, system, or expansion), transmission line, trace, optical connection, etc. that allows various circuit components (on common or different chips or chipsets) to interact with one another.

The processors 704 may include processor circuitry such as, for example, baseband processor circuitry (BB) 704A, central processor unit circuitry (CPU) 704B, and graphics processor unit circuitry (GPU) 704C. The processors 704 may include any type of circuitry or processor circuitry that executes or otherwise operates computer-executable instructions, such as program code, software modules, or functional processes from memory/storage 712 to cause the UE 700 to perform operations as described herein.

In some embodiments, the baseband processor circuitry 704A may access a communication protocol stack 736 in the memory/storage 712 to communicate over a 3GPP compatible network. In general, the baseband processor circuitry 704A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 708.

The baseband processor circuitry 704A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 712 may include one or more non-transitory, computer-readable media that includes instructions (for example, communication protocol stack 736) that may be executed by one or more of the processors 704 to cause the UE 700 to perform various operations described herein. The memory/storage 712 include any type of volatile or non-volatile memory that may be distributed throughout the UE 700. In some embodiments, some of the memory/storage 712 may be located on the processors 704 themselves (for example, L1 and L2 cache), while other memory/storage 712 is external to the processors 704 but accessible thereto via a memory interface. The memory/storage 712 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 708 may include transceiver circuitry and radio frequency front module (RFEM) that allows the UE 700 to communicate with other devices over a radio access network. The RF interface circuitry 708 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 726 and proceed to filter and amplify (with a low-noise amplifier) the signal. The signal may be provided to a receiver of the transceiver that down-converts the RF signal into a baseband signal that is provided to the baseband processor of the processors 704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 726.

In various embodiments, the RF interface circuitry 708 may be configured to transmit/receive signals in a manner compatible with NR or other access technologies.

The antenna 726 may include antenna elements to convert electrical signals into radio waves to travel through the air and to convert received radio waves into electrical signals. The antenna elements may be arranged into one or more antenna panels. The antenna 726 may have antenna panels that are omnidirectional, directional, or a combination thereof to enable beamforming and multiple-input, multiple-output communications. The antenna 726 may include microstrip antennas, printed antennas fabricated on the surface of one or more printed circuit boards, patch antennas, phased array antennas, etc. The antenna 726 may have one or more panels designed for specific frequency bands including bands in FR1 or FR2.

The user interface circuitry 716 includes various input/output (I/O) devices designed to enable user interaction with the UE 700. The user interface 716 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 700.

The sensors 720 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 722 may include software and hardware elements that operate to control particular devices that are embedded in the UE 700, attached to the UE 700, or otherwise communicatively coupled with the UE 700. The driver circuitry 722 may include individual drivers allowing other components to interact with or control various input/output (I/O) devices that may be present within, or connected to, the UE 700. For example, driver circuitry 722 may include a display driver to control and allow access to a display device, a touchscreen driver to control and allow access to a touchscreen interface, sensor drivers to obtain sensor readings of sensor circuitry 720 and control and allow access to sensor circuitry 720, drivers to obtain actuator positions of electro-mechanic components or control and allow access to the electro-mechanic components, a camera driver to control and allow access to an embedded image capture device, audio drivers to control and allow access to one or more audio devices.

The PMIC 724 may manage power provided to various components of the UE 700. In particular, with respect to the processors 704, the PMIC 724 may control power-source selection, voltage scaling, battery charging, or DC-to-DC conversion.

In some embodiments, the PMIC 724 may control, or otherwise be part of, various power saving mechanisms of the UE 700. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 700 may power down for brief intervals of time and thus save power. If there is no data traffic activity for an extended period of time, then the UE 700 may transition off to an RRC_Idle state, where it disconnects from the network and does not perform operations such as channel quality feedback, handover, etc. The UE 700 goes into a very low power state and it performs paging where again it periodically wakes up to listen to the network and then powers down again. The UE 700 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 728 may power the UE 700, although in some examples the UE 700 may be mounted deployed in a fixed location, and may have a power supply coupled to an electrical grid. The battery 728 may be a lithium ion battery, a metal-air battery, such as a zinc-air battery, an aluminum-air battery, a lithium-air battery, and the like. In some implementations, such as in vehicle-based applications, the battery 728 may be a typical lead-acid automotive battery.

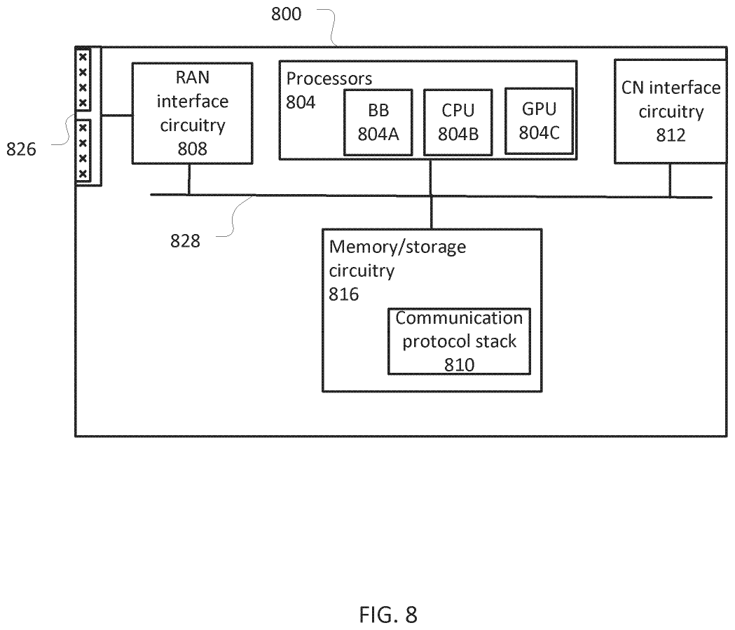

FIG. 8 illustrates an example base station 800 in accordance with some embodiments. The base station 800 may include processors 804, RF interface circuitry 808, core network (CN) interface circuitry 812, memory/storage circuitry 816, and antenna structure 826.

The components of the base station 800 may be coupled with various other components over one or more interconnects 828.

The processors 804, RF interface circuitry 808, memory/storage circuitry 816 (including communication protocol stack 810), antenna structure 826, and interconnects 828 may be similar to like-named elements shown and described with respect to FIG. 7.

The CN interface circuitry 812 may provide connectivity to a core network, for example, a 5th Generation Core network (5GC) using a 5GC-compatible network interface protocol such as carrier Ethernet protocols, or some other suitable protocol. Network connectivity may be provided to/from the base station 800 via a fiber optic or wireless backhaul. The CN interface circuitry 812 may include one or more dedicated processors or FPGAs to communicate using one or more of the aforementioned protocols. In some implementations, the CN interface circuitry 812 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method of operating a user equipment (UE), the method comprising: receiving, from a base station, a single downlink control information (DCI) to schedule simultaneous physical uplink shared channel (PUSCH) transmissions in a spatial-domain multiplexed (SDM) manner; and transmitting the simultaneous PUSCH transmissions with first and second antenna panels based on the single DCI, wherein: the single DCI includes one or more first indicator fields corresponding to a first PUSCH transmission of the simultaneous PUSCH transmissions, and one or more second indicator fields corresponding to a second PUSCH transmission of the simultaneous PUSCH transmissions, the one or more first indicator fields include: a first sounding reference signal resource indicator (SRI) field; or the first SRS field and a first precoding and layer information (PL) field; and the one or more second indicator fields include: a second SRI field; or the second SRI field and a second PL field.

Example 2 includes the method of example 1 or some other example herein, wherein the one or more first indicator fields are to schedule the first PUSCH transmission from the first antenna panel and the one or more second indicator fields are to schedule the second PUSCH transmission from the second antenna panel.

Example 3 includes a method of example 1 or some other example herein, further comprising: receiving, from the base station, a control signal to indicate that the simultaneous PUSCH transmissions are scheduled in the SDM manner, wherein the control signal is a radio resource control (RRC) signal, a media access control-control element, or a DCI signal.

Example 4 includes the method of example 1 or some other example herein, wherein the simultaneous PUSCH transmissions are to carry a transport block (TB) and the method further comprises: encoding the TB onto a plurality of layers, wherein a first layer of the plurality of layers is to be transmitted from the first antenna panel and a second layer of the plurality of layers is to be transmitted from the second antenna panel.

Example 5 includes the method of example 1 or some other example herein, further comprising: computing a total number of available resource elements from the plurality of layers; determining a TB size based on the total number of available resource elements; and encoding the TB onto the plurality of layers based on the TB size.

Example 6 includes the method of example 1 or some other example herein, wherein the simultaneous PUSCH transmissions are to carry a transport block (TB) and the method further comprises: encoding a first instance of the TB onto one or more layers to be transmitted from the first antenna panel; and encoding a second instance of the TB onto at least one layer to be transmitted from the second antenna panel.

Example 7 includes the method of example 6 or some other example herein, further comprising: computing a total number of available resource elements from the one or more layers to be transmitted from the first antenna panel; determining a TB size based on the total number of available resource elements; encoding the first instance of the TB onto the one or more layers to be transmitted from the first antenna panel based on the TB size; and encoding the second instance of the TB onto at least one layer to be transmitted from the second antenna panel based on the TB size.

Example 8 includes the method of example 6 or some other example herein, further comprising: encoding the first instance of the TB with a first redundancy version; and encoding the second instance of the TB with a second redundancy version.

Example 9 includes the method of example 8 or some other example herein, further comprising: determining the first redundancy version based on a redundancy version scheme field; and determining the second redundancy version based on a predefined offset from the first redundancy version or a predefined association with the first redundancy version.

Example 10 includes the method of example 1 or some other example herein, further comprising: determining the one or more first indicator fields schedule two PUSCH layers or less; determining the one or more second indicator fields schedule two PUSCH layer or less; determining, based on a first bit of a phase-tracking reference signal (PTRS)-demodulation reference signal (DMRS) association field, which PUSCH layer from the first antenna panel is to be used for a first PTRS port; and determining, based on a second bit of the PTRS-DMRS association field, which PUSCH layer from the second antenna panel is to be used for a second PTRS port.

Example 11 includes the method of example 1 or some other example herein, further comprising: determining the one or more first indicator fields or the one or more second indicator fields schedule more than two PUSCH layers; determining, based on two bits of a first phase-tracking reference signal (PTRS)-demodulation reference signal (DMRS) association field, which PUSCH layer from the first antenna panel is to be used for a first PTRS port; and determining, based on two bits of a second PTRS-DMRS association field, which PUSCH layer from the second antenna panel is to be used for a second PTRS port.

Example 12 includes a method of operating a base station, the method comprising: generating a single downlink control information (DCI) to schedule simultaneous physical uplink shared channel (PUSCH) transmissions in a spatial-domain multiplexed (SDM) manner; transmitting the single DCI to a user equipment (UE); and receiving, from the UE, simultaneous PUSCH transmissions transmitted from first and second antenna panels based on the single DCI, wherein: the single DCI includes one or more first indicator fields corresponding to a first PUSCH transmission of the simultaneous PUSCH transmissions, and one or more second indicator fields corresponding to a second PUSCH transmission of the simultaneous PUSCH transmissions, the one or more first indicator fields include: a first sounding reference signal resource indicator (SRI) field; or the first SRS field and a first precoding and layer information (PL) field; and the one or more second indicator fields include: a second SRI field; or the second SRI field and a second PL field.

Example 13 includes the method of example 12 or some other example herein, wherein the one or more first indicator fields are to schedule the first PUSCH transmission from the first antenna panel and the one or more second indicator fields are to schedule the second PUSCH transmission from the second antenna panel.

Example 14 includes the method of example 12 or some other example herein, further comprising: transmitting, to the UE, a control signal to indicate that the simultaneous PUSCH transmissions are scheduled in the SDM manner, wherein the control signal is a radio resource control (RRC) signal, a media access control-control element, or a DCI signal.

Example 15 includes a method of operating a user equipment (UE), the method comprising: receiving, from a base station, a single downlink control information (DCI) to schedule simultaneous physical uplink shared channel (PUSCH) transmissions in a spatial-domain multiplexed (SDM) manner; and transmitting the simultaneous PUSCH transmissions with first and second antenna panels based on the single DCI, wherein: the single DCI includes one or more indicator fields corresponding to a first PUSCH transmission and a second PUSCH transmission of the simultaneous PUSCH transmissions, the one or more indicator fields include: a sounding reference signal resource indicator (SRI) field; or the SRS field and a precoding and layer information (PL) field.

Example 16 includes the method of example 15 or some other example herein, further comprising: determining first and second sounding reference signal (SRS) resources are associated with the first antenna panel; determining third and fourth SRS resources are associated with the second antenna panel; and selecting one or more SRS resources from the first, second, third, and fourth SRS resources based on the SRI field.

Example 17 includes the method of example 16 or some other example herein, further comprising: receiving information to configure a single SRS resource set with a non-codebook usage to include the first, second, third, and fourth SRS resources; or receiving information to configure first and second SRS resource sets with a non-codebook usage, with the first SRS resource set to include the first and second SRS resources and the second SRS resource set to include the third and fourth SRS resources.

Example 18 includes the method of example 15 or some other example herein, further comprising: transmitting, to the base station, an indication of whether the UE supports coherent transmission between the first and second antenna panels.

Example 19 includes the method of example 15 or some other example herein, wherein the one or more indicator fields include the SRS field and the PL field, the UE is configured with a codebook that is either partially coherent or non-coherent, and the method further comprises: determining a transmit precoding matrix indicator (TPMI) based on the PL field; accessing a precoder from the codebook based on the TPMI; and using the precoder to precode one or more layers of a plurality of layers on even antenna ports mapped to the first antenna panel and remaining layers of the plurality of layers to odd antenna ports mapped to the second antenna panel.

Example 20 includes a method comprising: receiving a single downlink control information (DCI) to schedule simultaneous physical uplink shared channel (PUSCH) transmissions in a spatial-domain multiplexed (SDM) manner, the single DCI to include a channel state information (CSI) request field to trigger an aperiodic-CSI (AP-CSI) report; and encoding the AP-CSI report for transmission from one antenna panel of the UE or from two antenna panels of the UE.

Example 21 includes the method of example 20 or some other example herein, wherein the encoding the AP-CSI report comprises encoding the AP-CSI report for transmission from two antenna panels and the method further comprises: encoding the AP-CSI report onto a plurality of layers, wherein a first layer of the plurality of layers is to be transmitted from a first antenna panel of the two antenna panels and a second layer of the plurality of layers is to be transmitted from a second antenna panel of the two antenna panels.

Example 22 includes the method of example 20 or some other example herein, wherein the encoding the AP-CSI report comprises encoding the AP-CSI report for transmission from two antenna panels and the method further comprises: encoding a first portion of the AP-CSI report onto one or more layers to be transmitted from a first antenna panel of the two antenna panels; and encoding a second portion of the AP-CSI report onto at least one layer to be transmitted from a second antenna panel of the two antenna panels.

Example 23 includes the method of example 22 or some other example herein, further comprising: determining a first number of resource elements available for the AP-CSI report from the one or more layers to be transmitted from the first antenna panel; adjusting a size of the first portion of the AP-CSI report based on the first number of resource elements; determining a second number of resource elements available for the AP-CSI report from the at least one layer to be transmitted from the second antenna panel; adjusting a size of the second portion of the AP-CSI report based on the second number of resource elements.

Example 24 includes the method of example 20 or some other example herein, wherein the encoding the AP-CSI report comprises encoding the AP-CSI report for transmission from two antenna panels and the method further comprises: encoding the AP-CSI report onto one or more layers to be transmitted from a first antenna panel of the two antenna panels; and encoding the AP-CSI report onto at least one layer to be transmitted from a second antenna panel of the two antenna panels.

Example 25 includes the method of example 24 some other example herein, further comprising: determining a first number of resource elements available for the AP-CSI report from the one or more layers to be transmitted from the first antenna panel; determining a second number of resource elements available for the AP-CSI report from the at least one layer to be transmitted from the second antenna panel, wherein the second number is greater than the first number; adjusting a size of the AP-CSI report based on the first number of resource elements.

Example 26 includes the method of example 20 or some other example herein, further comprising: determining a first number of resource elements available for the AP-CSI report from one or more layers to be transmitted from a first antenna panel; determining a size of the AP-CSI report based on the first number of resource elements; encoding the AP-CSI report with the determined size onto the one or more layers to be transmitted from the first antenna panel; determining a second number of resource elements available for the AP-CSI report from at least one layer to be transmitted from a second antenna panel; determining the second number of resource elements is sufficient to accommodate the determined size; and encoding the AP-CSI report with the determined size onto the at least one layer to be transmitted from the second antenna panel based on said determining the second number of resource elements is sufficient to accommodate the determined size.

Example 27 may include an apparatus comprising means to perform one or more elements of a method described in or related to any of examples 1-26, or any other method or process described herein.

Example 28 may include one or more non-transitory computer-readable media comprising instructions to cause an electronic device, upon execution of the instructions by one or more processors of the electronic device, to perform one or more elements of a method described in or related to any of examples 1-26, or any other method or process described herein.

Example 29 may include an apparatus comprising logic, modules, or circuitry to perform one or more elements of a method described in or related to any of examples 1-26, or any other method or process described herein.

Example 30 may include a method, technique, or process as described in or related to any of examples 1-26, or portions or parts thereof.

Example 31 may include an apparatus comprising: one or more processors and one or more computer-readable media comprising instructions that, when executed by the one or more processors, cause the one or more processors to perform the method, techniques, or process as described in or related to any of examples 1-26, or portions thereof.

Example 32 may include a signal as described in or related to any of examples 1-26, or portions or parts thereof.

Example 33 may include a datagram, information element, packet, frame, segment, PDU, or message as described in or related to any of examples 1-26, or portions or parts thereof, or otherwise described in the present disclosure.

Example 34 may include a signal encoded with data as described in or related to any of examples 1-26, or portions or parts thereof, or otherwise described in the present disclosure.

Example 35 may include a signal encoded with a datagram, IE, packet, frame, segment, PDU, or message as described in or related to any of examples 1-26, or portions or parts thereof, or otherwise described in the present disclosure.

Example 36 may include an electromagnetic signal carrying computer-readable instructions, wherein execution of the computer-readable instructions by one or more processors is to cause the one or more processors to perform the method, techniques, or process as described in or related to any of examples 1-26, or portions thereof.

Example 37 may include a computer program comprising instructions, wherein execution of the program by a processing element is to cause the processing element to carry out the method, techniques, or process as described in or related to any of examples 1-26, or portions thereof.

Example 38 may include a signal in a wireless network as shown and described herein.

Example 39 may include a method of communicating in a wireless network as shown and described herein.

Example 40 may include a system for providing wireless communication as shown and described herein.

Example 41 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-20. (canceled)

21. A method comprising:
receiving, from a base station, a single downlink control information (DCI) to schedule simultaneous physical uplink shared channel (PUSCH) transmissions in a spatial-domain multiplexed (SDM) manner; and
generating the simultaneous PUSCH transmissions for transmission with first and second antenna panels based on the single DCI,
wherein:
the single DCI includes one or more first indicator fields corresponding to a first PUSCH transmission of the simultaneous PUSCH transmissions, and one or more second indicator fields corresponding to a second PUSCH transmission of the simultaneous PUSCH transmissions,
the one or more first indicator fields include: a first sounding reference signal resource indicator (SRI) field; or a first SRI field and a first precoding and layer information (PL) field; and
the one or more second indicator fields include: a second SRI field; or the second SRI field and a second PL field.

22. The method of claim 21, wherein the one or more first indicator fields are to schedule the first PUSCH transmission from the first antenna panel and the one or more second indicator fields are to schedule the second PUSCH transmission from the second antenna panel.

23. The method of claim 21, further comprising:
receiving, from the base station, radio resource control (RRC) signal to configure scheduling of the simultaneous PUSCH transmissions in the SDM manner.

24. The method of claim 21, wherein the simultaneous PUSCH transmissions are to carry a transport block (TB) and the method further comprises:
encoding the TB onto a plurality of layers, wherein a first layer of the plurality of layers is to be transmitted from the first antenna panel and a second layer of the plurality of layers is to be transmitted from the second antenna panel.

25. The method of claim 24, further comprising:
computing a total number of available resource elements from the plurality of layers;
determining a TB size based on the total number of available resource elements; and
encoding the TB onto the plurality of layers based on the TB size.

26. The method of claim 21, wherein the simultaneous PUSCH transmissions are to carry a transport block (TB) and the method further comprises:
encoding a first instance of the TB onto one or more layers to be transmitted from the first antenna panel; and
encoding a second instance of the TB onto at least one layer to be transmitted from the second antenna panel.

27. The method of claim 26, further comprising:
computing a total number of available resource elements from the one or more layers to be transmitted from the first antenna panel;
determining a TB size based on the total number of available resource elements;
encoding the first instance of the TB onto the one or more layers to be transmitted from the first antenna panel based on the TB size; and
encoding the second instance of the TB onto at least one layer to be transmitted from the second antenna panel based on the TB size.

28. The method of claim 26, further comprising:
encoding the first instance of the TB with a first redundancy version; and
encoding the second instance of the TB with a second redundancy version.

29. The method of claim 28, further comprising:
determining the first redundancy version based on a redundancy version scheme field; and
determining the second redundancy version based on a predefined offset from the first redundancy version or a predefined association with the first redundancy version.

30. The method of claim 21, further comprising:
determining the one or more first indicator fields schedule two PUSCH layers or less;
determining the one or more second indicator fields schedule two PUSCH layers or less;
determining, based on a first bit of a phase-tracking reference signal (PTRS)-demodulation reference signal (DMRS) association field, which PUSCH layer from the first antenna panel is to be used for a first PTRS port; and
determining, based on a second bit of the PTRS-DMRS association field, which PUSCH layer from the second antenna panel is to be used for a second PTRS port.

31. The method of claim 21, further comprising:
determining the one or more first indicator fields or the one or more second indicator fields schedule more than two PUSCH layers;
determining, based on two bits of a first phase-tracking reference signal (PTRS)-demodulation reference signal (DMRS) association field, which PUSCH layer from the first antenna panel is to be used for a first PTRS port; and
determining, based on two bits of a second PTRS-DMRS association field, which PUSCH layer from the second antenna panel is to be used for a second PTRS port.

32. A method comprising:
generating, for transmission to a user equipment (UE), a single downlink control information (DCI) to schedule simultaneous physical uplink shared channel (PUSCH) transmissions in a spatial-domain multiplexed (SDM) manner; and
receiving, from the UE, simultaneous PUSCH transmissions transmitted from first and second antenna panels based on the single DCI,
wherein:
the single DCI includes one or more first indicator fields corresponding to a first PUSCH transmission of the simultaneous PUSCH transmissions, and one or more second indicator fields corresponding to a second PUSCH transmission of the simultaneous PUSCH transmissions,
the one or more first indicator fields include: a first sounding reference signal resource indicator (SRI) field; or a first SRI field and a first precoding and layer information (PL) field; and
the one or more second indicator fields include: a second SRI field; or the second SRI field and a second PL field.

33. The method of claim 32, wherein the one or more first indicator fields are to schedule the first PUSCH transmission from the first antenna panel and the one or more second indicator fields are to schedule the second PUSCH transmission from the second antenna panel.

34. The method of claim 32, further comprising:
generating, for transmission to the UE, a radio resource control (RRC) signal a control signal to indicate that the simultaneous PUSCH transmissions are scheduled in the SDM manner.

35. One or more non-transitory, computer-readable media having instructions that, when executed, cause processor circuitry to:
receive, from a base station, a single downlink control information (DCI) to schedule simultaneous physical uplink shared channel (PUSCH) transmissions in a spatial-domain multiplexed (SDM) manner; and
generate the simultaneous PUSCH transmissions for transmission with first and second antenna panels based on the single DCI,
wherein:
the single DCI includes one or more indicator fields corresponding to a first PUSCH transmission and a second PUSCH transmission of the simultaneous PUSCH transmissions,
the one or more indicator fields include: a sounding reference signal resource indicator (SRI) field; or an SRI field and a precoding and layer information (PL) field.

36. The one or more non-transitory, computer-readable media of claim 35, wherein the instructions, when executed, further cause the processor circuitry to:
determine first and second sounding reference signal (SRS) resources are associated with the first antenna panel;
determine third and fourth SRS resources are associated with the second antenna panel; and
select one or more SRS resources from the first, second, third, and fourth SRS resources based on the SRI field.

37. The one or more non-transitory, computer-readable media of claim 36, wherein the instructions, when executed, further cause the processor circuitry to:
receive information to configure a single SRS resource set with a non-codebook usage to include the first, second, third, and fourth SRS resources.

38. The one or more non-transitory, computer-readable media of claim 36, wherein the instructions, when executed, further cause the processor circuitry to:
receive information to configure first and second SRS resource sets with a non-codebook usage, with the first SRS resource set to include the first and second SRS resources and the second SRS resource set to include the third and fourth SRS resources.

39. The one or more non-transitory, computer-readable media of claim 35, wherein the instructions, when executed, further cause the processor circuitry to:
generate, for transmission to the base station, an indication of whether the UE supports coherent transmission between the first and second antenna panels.

40. The one or more non-transitory, computer-readable media of claim 35, wherein the one or more indicator fields include an SRI field and a PL field, the processor circuitry is configured with a codebook that is either partially coherent or non-coherent, and the instructions, when executed, further cause the processor circuitry to:
determine a transmit precoding matrix indicator (TPMI) based on the PL field;
access a precoder from the codebook based on the TPMI; and
use the precoder to precode one or more layers of a plurality of layers on even antenna ports mapped to the first antenna panel and remaining layers of the plurality of layers to odd antenna ports mapped to the second antenna panel.
